(19) United States
(12) Patent Application Publication
(10) Pub. No.: US 2011/0197481 A1
(43) Pub. Date: Aug. 18, 2011

(54) Wire frame for attaching a free swinging sign panel made from paper card stock or similar materials

(76) Inventor: John R. Nasiatka, Northbrook, IL (US)

(21) Appl. No.: 12/930,774

(22) Filed: Jan. 18, 2011

Related U.S. Application Data
(60) Provisional application No. 61/337,816, filed on Feb. 12, 2010.

(51) Int. Cl. G09F 7/12; G09F 15/00

(52) U.S. Cl. 40/594; 40/606.01

(57) ABSTRACT

An outdoor sign having a wire support frame for a sign panel being attached to the supporting frame by folding over a small upper segment of the sign panel secured in place with staples or an adhesive in a manner to allow free movement of the sign panel within the supporting frame.

### BACKGROUND OF THE INVENTION

1. Field of the Invention

This invention relates to an inexpensive temporary outdoor signage as typically used to promote election candidates, yard sales, etc.

2. Description of Prior Art

One of the most popular type of an inexpensive, temporary yard sign is manufactured from weather resistant paper card stock material. The material is imprinted on one side of the material with the desired message. It is then folded over, in equal segments, 180°. The folded edge section now forms the top horizontal edge of the sign. The two (2) vertical edges are sealed with an adhesive or stapled together so that the printed message is visible from both sides. In using a sign manufactured in this manner the sign is typically held in place at the desired location by sliding it over an inverted U shaped wire support. The two (2) lower legs of the inverted U shaped wire support are pressed part way into the ground. The remaining exposed portion then supports the body of the sign.

Signs manufactured in this manner are subjected to a common problem of wind damage. In a strong wind, the large ridged face of the sign will cause the supporting wire frame to bend and/or pull the sign and its wire frame support out of the ground. Seldom, if ever, is the sign repaired or replaced in its original form due to damage and, for political/election signs, the volunteer workers originally placing the signs do not want to go back a second time to repair or replace the sign. The signs are then picked up by municipal workers and go in the garbage.

### SUMMARY OF THE INVENTION

The wire frame support in this invention is a simple inverted U shape wire frame. The width of the frame being several inches wider than the width of the sign panel being hung from the horizontal portion of the frame, while being centrally positioned between the vertical legs of the wire frame by one (1) of two (2) methods. 1) By inverted U shaped formations located at the corners of the horizontal portion of the frame. 2) An angle shaped off-set located in the upper corner of each vertical leg of the inverted U shape wire frame, to position the sign panel n a manner so as to allow free movement of the sign panel when it is attached to the horizontal portion of the frame. Attachment of the sign panel to the wire frame can be made by one (1) of two (2) methods. 1) The sign panel is printed on one side of paper card stock material. It is then folded over, in equal segments, 180° and placed over the horizontal portion of the wire frame. It is then sealed along the two (2) side edges with an adhesive or staples; 2) An alternate, less costly method is to print the sign on two (2) sides of the paper card stock. The paper card stock being half (½) the size of the paper card stock that is used when printed on one (1) side, plus approximately 1″ of additional material to fold over the horizontal portion of the wire frame to secure the sign body to the wire frame. The folded over material is secured with an adhesive or staples, resulting in considerable savings of material as compared to printing the sign body on one side as described in method one (1). The body of the sign in each example remains loose but secure and centered within the wire frame, allowing the sign to lift upwardly when subjected to a wind force. The central positioning of the sign within the frame and its attachment to the frame will be well understood when taken in conjunction with the five (5) drawings. Additionally, movement of the sign in a light wind will attract more attention than a stationary sign and, may be further enhanced by using reflective materials embedded in the body of the sign during the printing process.

### DESCRIPTION OF THE DRAWINGS

FIG. 1 An elevational view of the sign and wire frame assembly, showing the sign panel 12 positioned on the wire frame 10 with the inverted U formations 11 at each corner, thereby positioning the sign panel centrally between the two (2) legs of the wire frame 10 allowing for unrestricted upward movement when the sign panel is subjected to a wind force. The sign panel would return to a normal hanging position by its own weight.

FIG. 2 An enlarged view “A” of the corner of the wire frame 10 showing the inverted U formation 11 and sign body 12.

FIG. 3 An enlarged view section B-B showing a sign panel that was printed on one side of the paper card stock, folded in half, positioned on the wire frame 10 ready to be secured in place with staples or an adhesive along the vertical edges.

FIG. 4 An elevational view of the sign and wire frame assembly, showing the sign panel 12 positioned on the wire frame 14 with the angle shaped off-set 15 located in the upper corners of each vertical let of the wire frame 14, thereby positioning the sign panel centered between the two (2) vertical legs of the wire frame 14 allowing for unrestricted upward movement when the sign panel is subjected to a wind force. The sign body would return to a normal hanging position by its own weight.

FIG. 5 Enlarged view D showing the upper corner of the wire frame 14, the angle shaped off-set 15 and the sign body 12.

FIG. 6 An enlarged view showing a sign panel 12 that was printed on two (2) sides with a small section folded over the wire frame 10 secured in position with staples 13. The alternate method for securing the folded over section would be an adhesive, such as an adhesive strip with a protective liner that is removed to expose the adhesive and then pressed together and secured in place.

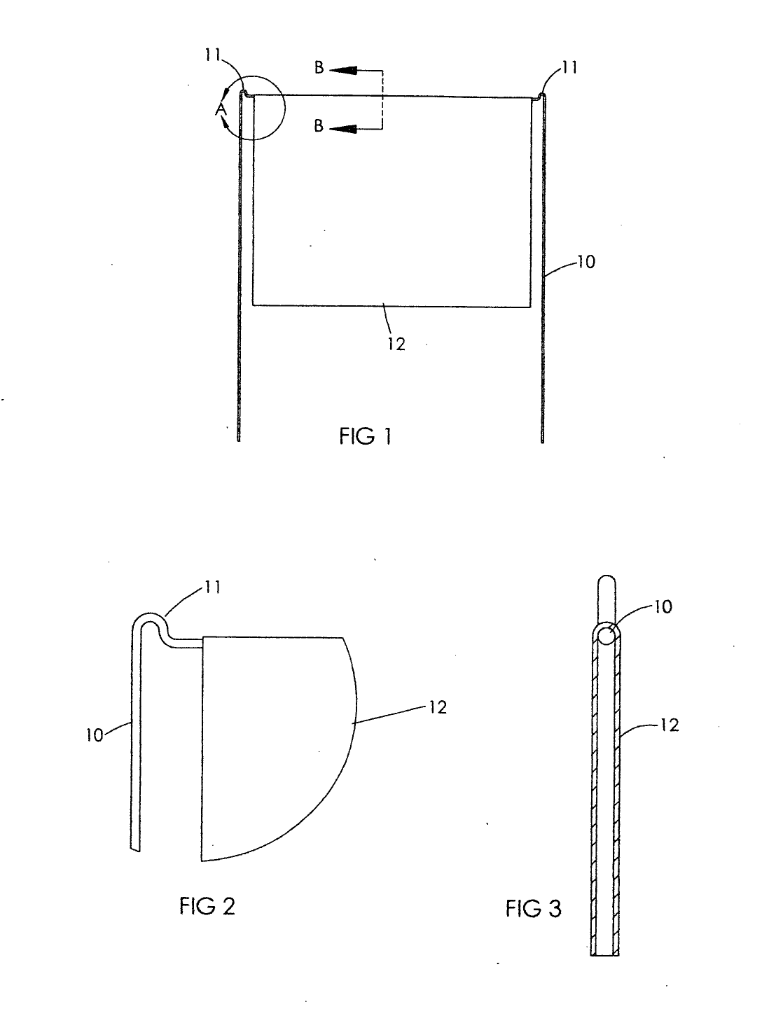

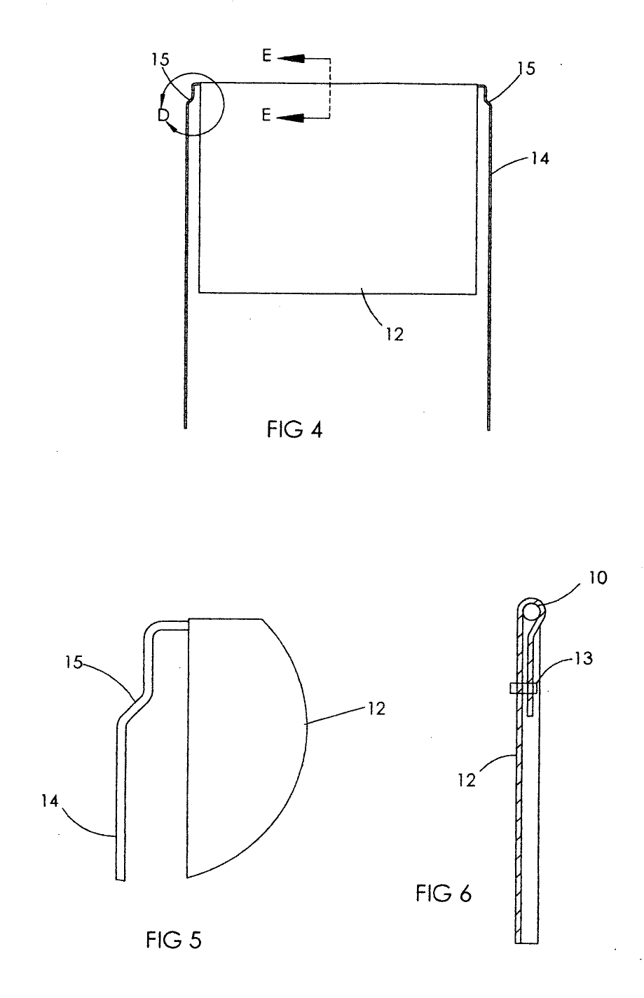

Obviously, many modifications and variations of the present invention are possible in light of the above teachings. Therefore, it is to be understood that within the scope of the appended claims, the invention may be appreciated otherwise than as specifically described above.

What is claimed and desired to be secure by a Letters Patent of the United States is:

1. An outdoor sign comprising of a metal wire support frame and a sign panel fabricated from commercially available materials such as paper card stock, plastic or similar materials. The support frame having 2 inverted U shaped formations in the horizontal header at the corner intersection with the vertical legs of the wire frame.

2. A sign panel as set forth in claim 1 wherein the sign panel having a small segment across the top of the panel to fold over the wire frame, secured in position with staples or an adhesive for securement to the wire frame.

3. A wire frame having an angle shaped off-set in the upper corner of each vertical leg of the inverted U shaped wire frame.
